(19) United States
(12) Patent Application Publication
(10) Pub. No.: US 2016/0078487 A1
(43) Pub. Date: Mar. 17, 2016

(54) LOCATION-BASED ADVERTISING IN A MOBILE BROADBAND NETWORK

(71) Applicant: ALLUNITE A/S, Søborg (DK)

(72) Inventors: Kasper Bloch Gevaldig, Charlottenlund (DK); Esben Elmøe, Holte (DK)

(21) Appl. No.: 14/888,817

(22) PCT Filed: May 5, 2014
(86) PCT No.: PCT/DK2014/050122

§ 371 Date: Nov. 3, 2015

(30) Foreign Application Priority Data
May 3, 2013 (DK) PA 2013 70250
Nov. 18, 2013 (DK) PA 2013 70700

(51) Int. Cl. G06Q 30/02; H04W 4/02

(52) U.S. Cl. CPC G06Q 30/0267; G06Q 30/0261; H04W 4/023

(57) ABSTRACT

A method and system for distributing advertising content in an advertising network, the advertising network comprising an advertising management system configured to manage advertising content; and a mobile broadband infrastructure comprising a plurality of base stations configured to provide communicatively coupling of mobile devices to the internet, the communicatively coupling at least partly being established as a mobile broadband connection; said mobile broadband infrastructure being communicatively coupled to said advertising management system; said advertising management system being configured to select and distribute advertising content to said mobile devices in accordance with advertising rules; and wherein said advertising rules provides for distributing said advertising content to mobile devices according to at least one of a location of the mobile devices or a location of the base stations.

### FIELD OF THE INVENTION

The present invention relates to distribution of advertising content in an advertising network comprising a mobile broadband infrastructure.

### BACKGROUND OF THE INVENTION

It is known to support services such as mobile broadband by advertising.

It would be useful to be able to improve the technical solution for distribution of advertising and/or the relevance of advertising content distributed to mobile devices connected to a mobile broadband infrastructure.

### SUMMARY OF THE INVENTION

The inventors have as part of the inventive process reached the above conclusion and have made an inventive technical solution of which an embodiment relates to a method of distributing advertising content AC in an advertising network AN, the advertising network AN comprising
an advertising management system AMS configured to manage advertising content AC; and
a mobile broadband infrastructure MBI comprising a plurality of base stations BS configured to provide communicatively coupling of mobile devices DEV to the internet I, the communicatively coupling at least partly being established as a mobile broadband connection;
said mobile broadband infrastructure MBI being communicatively coupled to said advertising management system AMS;
said advertising management system AMS being configured to select and distribute advertising content AC to said mobile devices DEV in accordance with advertising rules AR; and
wherein said advertising rules AR provides for distributing said advertising content AC to mobile devices DEV according to at least one of a location of the mobile devices DEV or a location of the base stations BS;
   the method comprising the steps of
the advertising management system AMS receiving a request for advertising content AC from a first mobile device DEV communicatively coupled to the internet I via a first base station BS;

the advertising management system AMS selecting an advertising content AC in accordance with said advertising rules AR and at least partly based on at least one of a location representation of said first mobile device DEV or a location representation of said first base station BS; and
distributing the selected advertising content AC to the first mobile device DEV in response to said request.

By the present disclosure is provided an advantageous method of distributing advertising content to mobile devices being connected to the internet by means of mobile broadband connection, also referred to as mobile data connection. According to the method, the advertising content is selected in accordance with a location representation related to the mobile device, e.g. the location representation obtained from the mobile device or from the base station(s), or in lack of mobile device location, the location of the connected base stations gives a rough indication of the location of the mobile device, possibly combined with similar rough indication representation from other nearby base stations. An identification of the base station is herein also considered a location representation, as the base stations are typically fixed structures and may thereby be considered geographical landmarks which are considered representations of locations. The advertising rules sets up algorithms or filters to enable the advantageous selection of advertising content which is particularly relevant for the geographical area where the user of the mobile device is currently situated, e.g. advertisements for local shops, businesses, etc. This may, e.g., be achieved by categorizing advertising content AC by geographical relevance.

Besides using the advertising content for making announcements and advertising own products and services, the mobile network operator may sell some or all of this advertising space to third party advertisers ADV. This opportunity can be used for the mobile network operator to offer ad-supported mobile broadband connections to users for free or at a reduced rate. The possibility for local relevance of the advertising, for example receiving a great offer for an ice cream at the ice cream café by Conservatory Water when walking in New York's Central Park on a hot summer afternoon, highly increases the likelihood that mobile device users will join ad-supported mobile broadband from a mobile network operator with that feature.

The mobile network operator may operate the advertising network AN and the advertising management system AMS. The communicatively coupling established between the mobile broadband infrastructure MBI and the advertising management system AMS may be via the internet I or a direction connection, or may be achieved by integrating the advertising management system AMS as part of the mobile broadband infrastructure MBI. The communicatively coupling provided by the base stations BS between the mobile devices and the internet preferably involves the mobile broadband infrastructure MBI.

The mobile device DEV is broadly understood as a device that is mobile. In preferred embodiments the mobile devices are handheld or portable devices such as, e.g., smartphones, tablets, PDAs, laptops, etc. In an embodiment the mobile device may be a fixed system in mobile setup, e.g. a computer, navigation system or smart-TV for automotive use, e.g. mounted in a car, etc. In a preferred embodiment several mobile devices DEV of same and/or different of the mentioned or other types are used simultaneously and/or sequentially, for various, possibly overlapping, periods.

A mobile device DEV is according to an embodiment characterized by being battery-powered. In a preferred embodiment the mobile device comprises a user interface, preferably comprising a display and/or other arrangement, e.g. a loudspeaker, for rendering advertising content and other information to a human user, solely or in combination with other content, information and/or input controls. The user interface in a preferred embodiment comprises a touchscreen, e.g. based on capacitive or resistive touchscreen technology, which may therefore provide functionality of both displaying information to the user and receiving input from the user, e.g. as being typically used in smartphones and tablet computers as understood by a person skilled in the art.

The mobile device may in an embodiment comprise one or more position detecting or determining arrangements, e.g. a GPS-receiver, an arrangement for multilateration, trilateration or triangulation with respect to base stations, WiFi positioning systems, etc., possibly combined such as in hybrid positioning systems, e.g. Assisted GPS technology. The mobile device is in an embodiment preferably configured to be able to communicate the determined position, on request and/or by choice, e.g. directly to a base station or wireless access point, or via the internet to a server or other internet-connected system, e.g. an advertisement management system.

In a preferred embodiment the mobile device comprises wireless internet connectivity, preferably at least by comprising an arrangement for connecting via mobile broadband technology, also known as mobile data technology, e.g. according to one or more of technologies know by the skilled person with reference to terms such as LTE-Advanced, LTE, IEEE 802.16m, HSPA+, WiMAX, UMTS, EDGE, etc. In an embodiment the mobile device is configured with mobile broadband technology as well as other wireless connection technologies, such as e.g. wireless local area network (WLAN) technology, also known as WiFi technology, preferably according to one or more of the IEEE 802.11 standards, e.g. 802.11g, 802.11n, 802.11ac, etc. In an embodiment where a mobile device DEV features WLAN technology, it is configured to be used in accordance with several of the IEEE 802.11 standards, e.g. 802.11b/g/n, as is widely known by a person skilled in the art. In an embodiment the mobile device is configured with other wireless data transfer technologies such as, e.g., Bluetooth, infrared, NFC, etc., e.g. IEEE 802.15.1 standardized wireless technology or any other suitable wireless technology. This may thereby in embodiments establish a kind of personal area network PAN, for example based on a Bluetooth group ad hoc network device or Bluetooth network access point device.

In an embodiment the mobile device is capable of connecting to the internet according to mobile broadband technologies e.g. as described above, but does not comprise WLAN-specific technology, i.e. WiFi technology.

A mobile broadband infrastructure MBI is generally understood as the interface between the internet infrastructure and mobile phones or other mobile devices with mobile broadband connectivity, e.g. mobile broadband USB sticks, tablet computers, etc., e.g. based on 3G or 4G technology. The base stations BS operated by a mobile network operator may, together with a connection to the internet, other network infrastructure and backbone components widely known by a person skilled in the art, form a mobile broadband infrastructure MBI. The technology may be based on any suitable known or future mobile broadband technology, e.g. LTE-Advanced, LTE, IEEE 802.16m, HSPA+, WiMAX, UMTS, EDGE, etc., as recognized by the skilled person.

Base stations BS refer to radio communication units placed at fixed locations, typically in relation to antennas on roofs, at masts or in towers, to support and enable a wireless telephone system and enable connection of mobile devices to the mobile broadband infrastructure MBI. The base stations comprise radio transceivers typically configured to provide internet access, and preferably also transmit telephone calls, in accordance with the above-mentioned technologies to and from the mobile device DEV.

In an embodiment the mobile device may at one point in time send several requests or a request that expands to several requests for advertising content. In an embodiment the advertising management server may respond by transmitting a bulk of combined advertising content.

It should be noted that the base stations BS distributing advertising content AC to mobile devices DEV by establishing a connection from the advertising management system AMS to the mobile device(s), does not necessarily need to provide further intelligence to the system insofar sufficient information is being forwarded to the advertising management system in connection with the request, thereby allowing the advertising management system to identify what to transmit in reply to the request.

Advertising content AC is generally understood as something (such as a short film or a written notice) that is shown or presented to the public to help sell a product or to make an announcement. In various preferred embodiments the advertising content comprises, e.g., text, images, video, audio, flash or other possibly interactive media, etc.

The advertising content may in embodiments, together with the information such as text, images, video, audio, flash or the like comprise a link such as a hyperlink and/or other information retrieving triggers such as a command, a script or the like. Hence, a user of the mobile device may e.g. activate the area where the advertising content is displayed at the mobile device, e.g. by a finger, a mouse marker and/or the like. Thereby, the user may initiate/activate the information retrieving trigger and thus be directed by a browser or the like on the mobile device to a home page or other information means such as a pop-up information window may be visualized upon the activation, to visualize further information related to the activated/clicked advertising content. Preferably, this/these information retrieving trigger(s), and thus the available further information, may be shifted together with advertising content provided to the mobile device based on the advertising management system over time.

The advertising content may thus in embodiments of the invention refer to a web page or other information not being part of the subscriber facilitated advertisement network as such. Hence, the subscriber may provide updates to the destination of the link, and the user will thus be presented to these updates over time even though the advertising content may remain the same. In other embodiments, the data provided when the activation of the advertising content is performed by the user at the mobile device may trigger a request for further information related to the activated/clicked advertising content from the advertising management system, and the advertising management system may upon this request provide the further information/data.

Different advertising content may in embodiments of the invention comprise/trigger similar information retrieving triggers upon user activation. Hence, a subscriber or another party as disclosed in this document may provide different advertisings to the mobile device, e.g. relating to different products, services or the like, but when the user triggers the information retrieving trigger relating to one of these different products, services or the like, the user may be presented to the same further information which may be common to one or more of the different advertisings.

The advertising network AN in a preferred embodiment denotes a virtual network comprising the advertising management system and all base stations participating in establishing the mobile broadband connections through which the advertising content is distributed. The advertising network AN in an embodiment enables location-based control and exposure of advertisements in the coverage area of the base stations.

An advertising management system AMS is generally understood as an integrated or distributed control system for the advertising network operator ANO to control the advertising network and any, some or all of storage, categorization, selection and distribution of advertisements. The advertisement management system AMS may preferably comprise an advertisement content server ACS and is preferably implemented, integrated or distributed, by data processing equipment DPE.

When referring to the internet I is generally understood as a minimum the Internet infrastructure, i.e. the worldwide network infrastructure that makes web pages and other web content of the World Wide Web accessible together with various other web services and internet distributed services, e.g. video streaming and email communication. In various embodiments the internet may be referring to the internet infrastructure as well as connected web servers and other connected servers.

The term web server can refer to either the hardware (the computer) or the software (the computer application) that helps to deliver web content WC that can be accessed through the Internet. A web server WS may be a separate computer system, a virtual server, typically running together with several other virtual servers at a computer, or a cloud based service where the server functionality is typically distributed to several hardware servers. The most common use of web servers is to host websites, but there are other uses such as gaming, video streaming, data storage or running enterprise applications.

An advantageous embodiment is obtained when the method is performed automatically by means of data processing equipment DPE.

The advertising management system AMS may preferably be a central system, and is in an embodiment performing the method of the invention automatically.

Data processing equipment may in a preferred embodiment comprise hardware, either integrated or distributed, suitable for implementing advertisement databases, selecting and combinations algorithms and web server functionality of the advertising management system AMS. The data processing equipment preferably comprises one or more processors, processing memory and non-volatile memory for storing data. The data processing equipment may comprise cloud-based services.

An advantageous embodiment is obtained when said communicatively coupling of the mobile devices DEV to the internet I by means of a mobile broadband connection is provided for free or at a, preferably reduced, rate in return for the users of the mobile devices agrees to receiving said advertising content AC.

According to the present disclosure, agreeing to receive advertising content may be expressed explicitly or implicitly by the users. In this context the mere use of the ad-supported mobile broadband connection is also considered agreeing. The reduction is in this context referred to mobile broadband packages not involving advertising or advertising according to other principles.

An advantageous embodiment is obtained when said advertising management system AMS is operated by an advertising network operator ANO.

In a preferred embodiment the advertising is managed and at least partly provided by an advertising network operator ANO. In a preferred embodiment the advertising network operator ANO comprises a legal or natural person who facilitates the advertising network AN and operates the advertising management system AMS. The advertising network operator may in an embodiment be motivated to enter into arrangements with mobile network operators as described in order to enlarge his inventory of advertising space, i.e. by adding the base stations, and happy, returning mobile device users. Further the advertising network operator in a preferred embodiment offers a part of the advertising space to advertisers ADV in accordance with an agreement entered with the mobile network operator. The agreement may, e.g., involve a splitting by a certain proportion of the revenue from selling advertising space.

An advantageous embodiment is obtained when said advertising management system AMS is further communicatively coupled to a WiFi-based advertising network comprising a plurality of geographically distributed wireless access points WAP, each of said wireless access points WAP being associated with a dedicated subscriber SUB,
the wireless access points WAP being configured to distribute subscriber-defined advertising content SAC to mobile devices DEV;
the advertising management system AMS defining a subscriber rule set SRS associating a subset of subscriber-defined advertising content SAC to each subscriber SUB; and
   the method further comprising the steps of
selecting a subscriber-defined advertising content SAC in accordance with said subscriber rule set SRS and geographical properties GP of said subscribers SUB and said at least one of a location representation of said first mobile device DEV or a location representation of said first base station BS; and
distributing the selected subscriber-defined advertising content SAC to the first mobile device DEV via said first base station BS.

In accordance with this advantageous method, the advertising network also contains a WiFi-based advertising network which distributes subscriber-defined advertising content to mobile device users when close enough to wireless access points to establish wireless broadband connections (as opposed to mobile broadband connections). In the WiFi-based advertising network, the subscriber associated with a wireless access point controls to a high degree the advertising content that is distributed via his wireless access point, and the advertising is therefore typically very locally relevant. Hence, it is advantageous to use this subscriber-defined advertising content SAC at least partly as the advertising content to provide also to mobile broadband users, when they are in the neighborhood of the relevant subscriber. The advertising rules AR may then include algorithms or filters for selecting subscriber-defined advertising content SAC when relevant, e.g. according to categorized geographical relevance.

A subscriber SUB is in a preferred embodiment a legal or natural person, e.g. a business, a shop, a mall, a café, or an owner or manager of such, typically a business with a physical, local, presence, who may be motivated to offer wireless internet access to customers and guests in return of being able to add advertisements to the web content retrieved via his wireless connection. The subscriber may own the wireless access points or the subscriber may e.g. according to a specific agreement have acquired the rights from the owner of the wireless access point(s). The subscriber may thereby ensure that his advertisement, e.g. defined by the subscriber rule set, may be broadcasted through his interest zone, i.e. the decentral coverage area DCA covered by the subscriber's wireless access points. In a preferred embodiment the subscriber enters into an agreement with the advertising network operator ANO, preferably in order to subscribe for advertisements to be delivered to his customers or guests, in return for being included in the advertising network offering automatic internet connection to customers and guests and therewith being able to offer his own subscriber-defined advertisements to the customers and guests. In an embodiment the subscriber may be considered a location provider, i.e.

providing a physical, geographical location for a wireless access point being part of a united network. The subscriber is in a preferred embodiment also the subscriber for the local internet connection required in order to make the wireless access point communicatively coupled to the internet.

Advertising content which is defined by the subscriber SUB, e.g. for promoting his own business, or advertisements he has sold to a third party, are denoted subscriber-defined advertising content SAC. In a preferred embodiment the subscriber may fully control the substance of his own advertisements, and setup rules for their exposure, cf. the subscriber rule set SRS.

The subscriber rule set SRS is understood as comprising rules for managing, e.g. categorizing, selecting, combining and/or avoiding conflict of interest, of sub scriber-defined advertising content SAC. A part of the subscriber rule set SRS preferably reflects an agreement with a subscriber SUB, and is in a preferred embodiment primarily controlled by the subscribers, and to a lesser degree by the advertiser network operator ANO.

In a preferred embodiment the wireless access points WAP are configured to provide wireless internet connectivity by means of radio communication, preferably at least by comprising an arrangement for establishing a wireless local area network (WLAN), also known as a WiFi network, preferably according to one or more of the IEEE 802.11 standards, e.g. 802.11g, 802.11n, 802.11ac, etc. In a preferred embodiment a wireless access point WAP is configured to be used in accordance with several of the IEEE 802.11 standards, e.g. 802.11b/g/n, as is widely known by a person skilled in the art.

A wireless access point WAP in a preferred embodiment associates the WLAN with a network identifier, typically, as known by the skilled person, a so-called service set identifier (SSID). Mobile devices are able to recognize a WLAN and differentiate between different WLANs due to the network identifier.

The radio transceiver of the wireless access point WAP, including the antenna configuration, is a main contributor to defining a space around the wireless access point WAP within which mobile devices DEV may connect to the wireless access point. The space, which is also referred to as a decentral coverage area DCA in the present disclosure, may be limited and defined by, among other things, radio transmission power of the wireless access point and/or the mobile device, antenna configuration, elevation, encoding technology, physical obstructions or reflectors, e.g. walls, concrete constructions, etc., interference or obscuring by other nearby radio transmitters, etc. It is noted that the covered space, the decentral coverage area DCA, forms a three-dimensional radiation pattern around the wireless access point antenna(s). Dependent on the defining parameters mentioned above, the decentral coverage area may in a typical embodiment extend between 10 and 300 meters from the antenna(s). A typical wireless access point may e.g. be useful within about 50-150 meters when placed outdoors with free line of sight to the mobile device, and e.g. about 20-40 meters when used indoors.

In an embodiment the wireless access point WAP is configured with WLAN technology as well as wired connection technologies, e.g. a number of Ethernet ports.

In a preferred embodiment, the wireless access point is communicatively coupled to the internet I via a router, which may be a separate hardware unit or integrated with the wireless access point, and any suitable last-mile internet networking technology as widely known by a person skilled in the art, such as, e.g., an optical fiber connection, ADSL or other DSL connection typically utilizing telephone wires, cable modems utilizing cable TV network infrastructure, or wireless technologies such as, e.g. WiMAX or LTE, or even a further WLAN connection with a same or different network identifier to another wireless access point.

A geographical property GP of a wireless access point WAP may e.g. refer to an estimated position EP or a decentral coverage area DCA of the wireless access point, e.g. as disclosed below, but may also comprise absolute or relative indications of distance, e.g. denoted in meters, signal strength, etc.

Estimated position EP relates to a location of a wireless access point WAP. The estimated position EP may preferably be registered by a human user, but may additionally or alternatively be determined at least partly from location representative data LRD received from one or more mobile devices DEV, possibly together with other information. The estimated position EP may be subject to a known or unknown degree of certainty, e.g. indicated by a radius within which the wireless access point is probably located, or a number of curve intersections, curves or curved planes at which the wireless access point is probably located. The estimated position EP is preferably indicated in absolute terms, e.g. by latitude and longitude, map coordinates, a street address, etc., possibly together with the elevation, but may in an embodiment also or instead be indicated with relative terms.

Location representative data LRD comprises information related to a position of a mobile device DEV. The location representative data may relate directly to a position of the mobile device, or they may, e.g., relate to one or more base stations within reach of the mobile device, and thereby in turn relate to the position of the mobile device. The location representative data LRD may indicate an absolute position, e.g. by latitude and longitude, map coordinates, a street address, etc., possibly together with the elevation, or it may indicate a relative position or other data that may be used alone or together with yet other information to derive an absolute or relative position, e.g. estimated distances to base stations, received signal strength indications, differentiation between indoor and outdoor, high or low elevation, etc. The location representative data may e.g. comprise a position and an indication of the degree of uncertainty, e.g. in terms of a radius.

The location representative data may e.g. be obtained by means of a GPS-receiver associated with the mobile device, an arrangement for multilateration, trilateration or triangulation of the position of the mobile device with respect to base stations, a WiFi positioning system, etc., or simply by having a user indicating a position. The technologies for obtaining location representative data may be combined in hybrid positioning systems, e.g. Assisted GPS technology, etc.

It is noted that the terms “location” and “position” are used interchangeably to express similar meaning in the present disclosure. The location representative data LRD may in a preferred embodiment also be used for the disclosed location representation.

An advantageous embodiment is obtained when the wireless access points WAP are further configured to distribute advertising network operator-defined advertising content AAC to mobile devices DEV; and
wherein the advertising management system AMS further defining a compliance rule set CRS, said compliance rule set CRS defining a subset of the advertising network operator-defined advertising content AAC as compliant with the individual subscribers SUB;
   the method further comprising the steps of
selecting an advertising network operator-defined advertising content AAC in accordance with said compliance rule set CRS and geographical properties GP of said subscribers SUB and said at least one of a location representation of said first mobile device DEV or a location representation of said first base station BS; and
distributing the selected advertising network operator-defined advertising content AAC to the first mobile device DEV via said first base station BS.

Advertisements which are defined by the advertising network operator ANO, preferably advertisements sold to advertisers ADV or e.g. for promoting the advertising network or making announcements, are denoted advertiser network operator-defined advertising content AAC. In a preferred embodiment the subscriber may fully or partly control the substance of advertising network operator-defined advertisements AAC that are being exposed via his wireless access point by configuring a compliance rule set CRS. Also the advertiser ADV and/or the advertising network operator ANO may influence the exposure behavior of advertising network operator-defined advertisements AAC by configuring the compliance rule set CRS.

In the present context a compliance rule set CRS comprises rules for managing, e.g. categorizing, selecting, combining and/or avoiding conflict of interest, of advertising network operator-defined advertising content AAC. A part of the compliance rule set CRS preferably reflects agreements with subscriber SUB and possibly also advertisers ADV, and is in a preferred embodiment primarily controlled by the subscribers, the advertiser and the advertiser network operator ANO.

An advantageous embodiment is obtained when the advertisement content AC comprises advertising network operator-defined advertising content AAC and subscriber-defined advertising content SAC.

An advantageous embodiment is obtained when at the step of selecting advertising content AC to distribute to the first mobile device via said first base station is performed at least partly in dependency with a user profile UP associated with the mobile device or a user of the mobile device.

User profile UP generally relates to information about the mobile devices or their users. According to an embodiment, the user profile may advantageously be applied for making the advertising more targeted, e.g. by correlation with user habits, user defined preferences, etc. The user profile may in a preferred embodiment be updated by the user, thereby allowing the user actively to affect the types of advertisement transmitted to him by the advertising management system. The user profile may also be updated on the basis of analysis of the web content or the web search results accessed by the mobile device or the user of the mobile device, thereby making it possible automatically to correlate the user's habits or interest without requiring inputs from the user.

The user profile may in an embodiment be anonymous in the sense that it only relates to an identifier, e.g. a MAC-address or other distinctive identifier of the mobile device, an email-address, an alias, etc. In an embodiment the user profile is related to a named or otherwise identified user, e.g. by social security number, a user ID of a social media network, a digital certificate, etc. In an embodiment part of the user profile is derived from social media network and other public or private sources.

The identification of a mobile device sufficient to lookup a corresponding anonymous user profile may be performed as soon as the user's mobile device is moved into a coverage area of one of base stations, at least if the mobile telecommunication features of the mobile device activated.

If user identification is desired to lookup a personal user profile, this may be obtained in various ways. In an embodiment the user is required to login to the network by being redirected to a login page upon moving the mobile device into a coverage area of a participating base station. In an embodiment the user is asked to create a profile upon the very first connection attempt to the network, and as part of the profile the mobile device is identified in order to be able to associate the user with the particular mobile device, e.g. by using the MAC-address or IMEI-number as key, for further connections thereafter. In an embodiment a login system of a popular social media network is used to ease the login procedure and profile creation for new users of the united network.

An advantageous embodiment is obtained when the advertising rules AR furthermore relates to a user profile UP associated with the mobile device or a user of the mobile device, and wherein the advertising content AC is further selected in accordance with the user profile UP.

According to an advantageous embodiment of the invention, the user profile may advantageously be applied for making the advertising even more targeted, e.g. by correlation with user habits, user defined preferences, etc.

An advantageous embodiment is obtained when the user profile is updated by means of input from a user.

The user profile may advantageously be updated by the user, thereby allowing the user actively to affect the types of advertisement transmitted to him by the advertising management system.

An advantageous embodiment is obtained when the user profile is updated in response to analysis of web content or web search results accessed by the mobile device or the user of the mobile device.

The user profile may also be updated on the basis of analysis of the web content or the web search results accessed by the mobile device or the user of the mobile device, thereby making it possible automatically to correlate the user's habits or interest without requiring inputs from the user.

An advantageous embodiment is obtained when the advertising management system AMS selecting an advertisement content in accordance with said advertising rules and at least partly based on at least one of a location representation of said first mobile device DEV or a location representation of said first base station BS is based on a unique ID UID associated with said request.

This may provide an advantageous way of identifying a location-fixed structure, e.g. a base station, or position so as to be able to identify the proper, geographically relevant, advertising content to provide to the mobile device transmitting the request based on the rule set.

The unique ID UID refers to an identifier, e.g. serving to identify through which base station a mobile device is connecting to the internet and should receive advertising content AC. The unique ID may preferably be included in the requests for advertising content sent from the mobile device, or the unique ID may be injected in the request during the transmission of the request to the advertising management system. This may e.g. be achieved by having the base station or an upstream network unit configured to add the unique ID to the request upon forwarding the request to the advertising management system. In a preferred embodiment the unique ID UID identifies the base station through which the requests are transmitted from the mobile device DEV by comprising a hardware identifier, preferably a media access control address (MAC-address), of the base station. In various other embodiments, the unique ID may comprise e.g. a unique identifier of said base station or other identification, a position of the base station or the user, etc.

An advantageous embodiment is obtained when said unique ID UID is determined based on a positioning system of said mobile device performing the requests for advertising content AC.

The location representation is preferably provided as unique ID UID which itself relates to position. Preferably, the positioning system is a Global Positioning System (GPS) or Assisted GPS, but it is understood that any suitable positioning system may be used in further aspects of the invention. The unique ID may when based on position, e.g. comprise latitude and longitude, map coordinates, a street address, etc., possibly together with the elevation.

An advantageous embodiment is obtained when said unique ID UID is determined based on multilateration, trilateration or triangulation, preferably with respect to a plurality of base stations BS, to determine the position of said mobile device performing the request(s) for advertising content AC.

In this context it should be noted that multilateration, trilateration or triangulation evidently may be performed on the basis of as few or a many signal levels needed to obtain the desired position. The point is therefore not the specific number of detected signal levels measured at the mobile device, but rather that the signal levels measured at the mobile device will suffice for determination of the position of the mobile device, preferably at least to a degree sufficient to identify the subscriber.

An advantageous embodiment is obtained when said location representation is combined into the requests for advertisement content.

The location representation is in this preferred embodiment part of the request for advertisement content, e.g. as a part of an URL or URI, an HTTP GET- or PUT-request, meta- or header-information in e.g. one of the protocols of the TCP/IP system, as part of a SOAP-message or other web service request, an asynchronous HTTP requests, XML HTTP requests, etc.

An advantageous embodiment is obtained when the combining of said location representation into said requests for advertising content is triggered by said mobile device DEV.

It may thus within the scope of the invention be possible to make the mobile device trigger the combining of the location representation into the request by means of dedicated software, e.g. an app downloaded and executed at the mobile device from which the request originates.

An advantageous embodiment is obtained when the combining of said location representation into said requests for advertising content is triggered by said advertising network AN.

It may moreover within the scope of the invention be possible that the advertising network, e.g. a component thereof, triggers the combining of the location representation into the request. This triggering may e.g. be performed in hardware interfaces along the communication line between the mobile device and a web server from which the mobile device is retrieving web content. A very advantageous embodiment in this context would be a component such as a proxy server related to the base station or an upstream network component of the mobile broadband infrastructure MBI.

An advantageous embodiment is obtained when the combining of said location representation into said requests for advertising content is triggered by the base station through which the request is transmitted from said mobile device DEV.

In embodiments of the invention, the location representation may, if possible, be added anywhere between the mobile device and the advertising management system so that it is possible to determine the geographical relevance.

The requests may be triggered by modified web content MWC generated in response to a user-initiated request for web content WC.

An advantageous embodiment is obtained when the base stations BS are further configured to communicatively couple said mobile devices DEV to the internet I for retrieval of web content WC.

Web content WC is understood as the content from web servers WS that the mobile device accesses by means of the internet connectivity. The web content is typically HTML-documents together with any associated sub resources. The web content may include web server advertising, e.g. from banner exchange services, which in this context is also referred to as web content, as opposed to advertising content, which in the present context refers to advertising managed by the advertising network operator and advertising management system.

An advantageous embodiment is obtained when said step of the advertising management system AMS receiving a request for advertising content AC from the first mobile device DEV via the Internet I is preceded by the steps of:
the first mobile device DEV requesting web content WC via the first base station BS; and
the first mobile device DEV receiving said requested web content WC as modified web content MWC from said first base station BS, the first mobile device initiating and transmitting said request for advertising content AC in response to receipt of said modified web content.

In a preferred embodiment the mobile device receives advertising content or is triggered to request advertising content each time or some time it requests web content, e.g. a web page from a web server. This may be achieved by modifying the requested web content into modified web content before relaying it to the mobile device.

It is noted, that the present method may in a preferred embodiment be carried out iteratively over time, in which case the statement that the steps of requesting web content and receiving modified web content precede the steps of requesting advertising content and transmitting advertising content is to be understood as relating to each or some of the iterations. In other words, the mentioned requests for advertising content may take place at different times, each or some time preceded by steps of requesting web content and receiving modified web content.

An advantageous embodiment is obtained when said request from the first mobile device DEV for advertising content is triggered by the modified web content MWC received by the mobile device.

The web content WC may, e.g., have been modified into modified web content MWC included some or all of the original web content, together with script(s) or instructions which when processed causes the mobile device to make the requests for advertising content.

In a preferred embodiment, modified web content MWC refers to web content WC modified by, e.g., a proxy server PS and sent to a mobile device DEV by means of a base station BS. The modification preferably comprises addition of a reference to an advertising content AC, e.g. in the form of a URL involving an advertising management system AMS or advertising content server ACS, and/or a script configured to establish such a reference. In an embodiment the script may establish an update of the advertising content AC at predefined intervals. In an alternative embodiment the modification may comprise combining the web content WC and the advertising content AC into a modified web content MWC.

An advantageous embodiment is obtained when said modified web content MWC comprises the web content WC and further script(s) or instructions.

Said script or instructions may comprise the unique ID or location representation. The modification may add script or instructions which, when executed, may reserve space on the screen of the device for the advertising content which is received in response to the request for advertising content. The script or instruction may also comprise a software code which, when executed, manipulates the mobile device to transmit the request for advertising content.

An example of an instruction may e.g. be an HTML-tag instructing a browser to retrieve an image from an URL, the URL pointing at a web server of the advertising management system and the URL further comprising a query string, preferably comprising the location representation or unique ID, possibly together with further parameters for facilitating the advertising management system in selecting targeted advertising content. An injected HTML-instruction may in an embodiment look like, e.g., <IMG SRC=“http://www.allunite.com/get_ad/?pos=40.773863,−73.96488” alt=“AllUnite advertisement” height=“25” width=“75”/>.

An example of a script may be a javascript-implemented interval function which may cause a browser to periodically retrieve an image as widely understood by a person skilled in the art, from an URL comprising a query string containing the location representation or unique ID as described above. The retrieval of the advertisement may be performed as a normal download of a sub resource in a browser, or it may be carried out by asynchronous requests, e.g. an asynchronous XMLHttpRequest. The script itself may be modified into the web content html document, or the modification may consist in adding an HTML-tag which when processed causes download and execution of a script-file.

The reservation of space on the screen of the mobile device may comprise adding, e.g., an IMG, OBJECT or DIV-tag to an HTML-document, manipulating a CSS-document, adding an inline frame (iframe) to a web page, etc. It is noted that the advertising content may comprise images, text, audio or video, etc. Combinations of the examples or alternatives including other instructions in e.g. HTML or CSS files, or other kinds of scripts, e.g. with further functionality or applicable to different platforms, may be readily available as will be recognized by a person skilled in the art.

An advantageous embodiment is obtained when the advertising content AC is associated to an industrial classification code.

When associating advertising content to an industrial classification code, it is thereby possible to establish a well-defined description of the advertising, e.g. to compare with a mobile device user's user profile, and it is furthermore possible to establish whether the advertising content, when used in another context would conflict with other advertising content.

An advantageous embodiment is obtained when the advertising content AC is categorized.

By categorizing the advertising content, it may be possible to better target the user of the mobile device connected to the advertising network. The categorization of the advertising content may at the step of selecting advertising content AC be correlated with the advertising rules AR and/or a user profile, either obtained from the specific user as described above regarding user profiles UP, or obtained by other analysis of the base station's users. The categorization may, e.g., involve age, gender, interests, etc.

An advantageous embodiment is obtained when the advertising management system AMS facilitates a central uploading of individual advertising content AC via the Internet I.

Advertising content may be uploaded to a shared central server in a central advertising management system. In this way the advertiser may simply choose from a portal of centrally available templates. In this way, even small stores, libraries, coffee shops, offices, etc., may become a part of an advertising network, without even being required a computer.

An advantageous embodiment is obtained when said web content WC retrieved by said mobile device DEV is received and displayed at the mobile device.

In a preferred embodiment, the mobile devices uses mobile broadband connections in order to gain access to the internet for retrieving web content. The web content is preferably displayed at the mobile device, and for this purpose, the mobile device preferably comprises a user interface, preferably comprising a display and/or other arrangement, e.g. a loudspeaker, for rendering advertising content and other information to a human user, solely or in combination with other content, information and/or input controls. The user interface in a preferred embodiment comprises a touchscreen, e.g. based on capacitive or resistive touchscreen technology, which may therefore provide functionality of both displaying information to the user and receiving input from the user, e.g. as being typically used in smartphones and tablet computers as understood by a person skilled in the art.

An advantageous embodiment is obtained when said advertising content AC transmitted to said mobile device DEV is received and displayed at the mobile device.

The advertising content is preferably displayed to a user at the mobile device in a similar way as described above regarding the display of web content.

An advantageous embodiment is obtained when the advertising content AC distributed to the mobile device DEV is received and displayed at the mobile device in addition to web content WC requested by the mobile device DEV.

The advertising content is preferably displayed in addition to web content, e.g. in a pop up window, in a banner at the top, bottom and/or side(s) of the display, in suitable whitespace anyway produced by the web content, or in an embodiment by substituting some of the web content with the advertising content, preferably other advertising content received as web content opposed to the advertising content received as such from the advertising management system.

An advantageous embodiment is obtained when the advertising content AC transmitted to the mobile device DEV is displayed at the mobile device simultaneously with web content WC requested by the mobile device DEV.

In a preferred embodiment the advertising content is displayed simultaneously with displaying of web content to a user at the mobile device, preferably by a bar at the bottom or top of a web browser window.

In this context simultaneous or parallel displaying means that both web content and advertising content appear to the user at substantially the same time under appropriate circumstances, i.e. when the network etc. allows for all content to be fetched in a reasonably short time, and when the device's display, or on devices with resizable windows: the window, is sufficiently large to show all content. In other words, content are considered displayed in parallel or simultaneously also when different parts appear clearly sequentially e.g. due to slow internet connection, slow servers or slow mobile device, or when different parts cannot actually be seen at the same time because of the screen or window being too small, but can be seen individually by scrolling the content in the window.

By displaying the advertising content parallel at the mobile device, it may be possible for the user of the mobile device to visually see both the advertisement content and a visual presentation of the user accessed web content at the same time. This will, in the preferred embodiment, enable that the user may access the Internet in a usual manner without being interrupted by pop-ups, relaying web-sites, etc, while browsing the internet. The added advertisement content may simply be graphically added to the displayed website, thereby basically expanding the view with the advertisement content of the subscriber or the centrally determined advertisement. The added advertisement content may advantageously be added in the top window, in the bottom part of the window and/or to the left and/or to the right of the user accessed web content. The added advertisement may e.g. be inserted by a relatively simple modification of the Document Object Model DOM established at the mobile device.

An advantageous embodiment is obtained when the mobile broadband infrastructure MBI comprise proxy servers PS.

In the present context a proxy server PS of a base station BS or related to one or more base station BS, e.g. by being located upstream in the mobile broadband infrastructure MBI and thereby get in contact with all mobile data communication handled by these one or more base stations, is understood as a component, typically implemented by a processor and memory in a server, and acts as an intermediary for requests from and to mobile devices seeking resources from web servers. The proxy server is configured to analyze and manipulate the content of network packages sent through the base stations.

The proxy server is preferably formed by hardware controlled by an operating system, e.g. an embedded linux system, comprising proxy server control software. The hardware may preferably comprise a CPU, RAM and static/non-volatile memory. Proxy server software may typically be updated, e.g. by firmware upgrade mechanisms, which may preferably be autonomous or controlled from remote connection.

An advantageous embodiment is obtained when said proxy servers trigger the association of a location representation or unique ID.

In a preferred embodiment the proxy server modifies web content requested by a mobile device connected to the base station so that the modified web content is made to provide the association of the location representation or unique ID to the mobile device, which in turn may provide the location representation or unique ID with its request for advertising content. In an embodiment, the proxy server modifies the requests for advertising content when on their way from the mobile device to the advertising management system in order to associate the request with the location representation or unique ID that can be used with the advertising rules AR to determine geographically relevant advertising content.

An advantageous embodiment is obtained when the mobile device DEV connecting to the base station BS receives advertising content AC from the advertising management system AMS and web content WC from the internet I, preferably from a web server WS connected to the internet.

By arranging the transmission of advertising so that advertising content AC is served from a central or dedicated advertising server or advertising network, whereas the web content WC that the user requested is still served from the internet source, typically a web server, that the user requested web content from, a beneficial and useful embodiment is provided which is very suitable for most of the relevant use cases where a user agrees to or is required to be exposed to advertising together with the web content he or she wanted to be served to him or her.

An advantageous embodiment is obtained when the mobile device DEV connecting to the base station BS receives advertising content AC from the advertising management system AMS and web content WC from the internet I, preferably from a web server WS connected to the internet, wherein the web content WC is transmitted from the internet I without being relayed via the advertising management system AMS.

According to an embodiment web content should preferably be requested directly from the web source instead of being relayed though the advertising management system. It is thereby ensured that the advertising management system does not act as a bottleneck to browsing performed by the user of the mobile device. An advantageous feature in an embodiment is that the processing of web content WC to make modified web content MWC is distributed to decentral, e.g., proxy servers, preferably located in relation to each base station or each small group of base stations. The modified web content MWC triggers the mobile device to request advertising as disclosed and preferably only this advertising request is handled by the advertising management server AMS.

An advantageous embodiment is obtained when said communicatively coupling of mobile devices DEV to the internet I does not involve WiFi-technology.

An advantageous embodiment is obtained when the base stations BS are configured to enable communicatively coupling of a plurality of mobile devices to the internet I regardless of customer relationships or service accessibilities indicated by subscriber identity modules comprised by said plurality of mobile devices.

A further embodiment relates to a system for facilitating advertising in an advertising network AN, the system comprising
an advertising management system AMS configured to manage advertising content AC; and
a mobile broadband infrastructure MBI comprising a plurality of base stations BS configured to provide communicatively coupling of mobile devices DEV to the internet I, the communicatively coupling at least partly being established as a mobile broadband connection;
said mobile broadband infrastructure MBI being communicatively coupled to said advertising management system AMS;
said advertising management system AMS being configured to select and distribute advertising content AC to said mobile devices DEV in accordance with advertising rules AR; and
wherein said advertising rules AR are configured to enable said selection of advertising content AC according to at least one of a location of the mobile devices DEV or a location of the base stations BS.

An advantageous embodiment is obtained when the system further comprises features described in the above description of the method of distributing advertising content AC in an advertising network AN.

An advantageous embodiment is obtained when said system further comprises features for carrying out the above described method of distributing advertising content AC in an advertising network AN.

A further embodiment relates to a non-transitory computer-readable storage medium storing a set of instructions for distributing advertising content AC in an advertising network AN, the advertising network AN comprising an advertising management system AMS configured to manage advertising content AC; and a mobile broadband infrastructure MBI comprising a plurality of base stations BS configured to provide communicatively coupling of mobile devices DEV to the internet I, the communicatively coupling at least partly being established as a mobile broadband connection; said mobile broadband infrastructure MBI being communicatively coupled to said advertising management system AMS; said advertising management system AMS being configured to select and distribute advertising content AC to said mobile devices DEV in accordance with advertising rules AR; and wherein said advertising rules AR provides for distributing said advertising content AC to mobile devices DEV according to at least one of a location of the mobile devices DEV or a location of the base stations BS;
said instructions, when executed by one or more processors, cause the following steps to be carried out:
the advertising management system AMS receiving a request for advertising content AC from a first mobile device DEV communicatively coupled to the internet I via a first base station BS;
the advertising management system AMS selecting an advertising content AC in accordance with said advertising rules AR and at least partly based on at least one of a location representation of said first mobile device DEV or a location representation of said first base station BS; and
distributing the selected advertising content AC to the first mobile device DEV in response to said request.

In an embodiment of the invention, a mobile device may be provided with an app, i.e. software, to be executed at the individual mobile device. The app will be executed as a visual display of a compass. The compass will direct a user of the mobile device to a stronger network by physically showing the direction.

The compass function will technically be based on detection of signal levels related to one or preferably the closest wireless access point. The signal detection is performed in the mobile device and a display will illustrate a direction towards a stronger network signal. The app is very attractive to a user, due to the fact that the user does not have to specify a specific local network to search for, but rather just search for a wireless access point providing a stronger wifi connection within the united network established by the wireless access points of the advertising network.

In an embodiment of the invention, a website may also be applied for the purpose of being directed to physical shops or physical providers for the purpose of obtaining or buying advertised goods or information.

In an embodiment of the invention, it is possible to provide a subscriber associated to more than one wireless access point, e.g. a shop owner having five wireless access points, with a heap map, showing or reflecting where mobile devices have moved within the store at a given time or one or more specified time periods.

In an embodiment of the invention, it will be possible for the subscriber to assign different of the subscriber's wireless access point with different dedicated advertisement. It may therefore be possible for a subscriber, e.g. a shop owner or a library to give specific advertisement to a mobile device in dependency of where the mobile device is in the store. This may e.g. be done advantageously by the subscriber when dedicating advertisement regarding books in one subscriber-defined advertising content to a wireless access point located in the subscriber's book department and dedicating advertisement regarding delicious meat in another subscriber-defined advertising content to a wireless access point located in the subscriber's butcher department.

In an embodiment of the invention, a subscriber may be associated to more than one wireless access point. This may e.g. be defined centrally in the advertisement management system. This application of a multiple numbers or wireless access points associated to one subscriber may be applied throughout the present application. The group may be seen from the advertising management system as one uniform group of wireless access point and the advertising management system may thereby submit the same subscriber-defined advertising content to all wireless access point in the group. The advertising management system may also handle the wireless access points individually and transmit different subscriber-specified advertising content to the different wireless access points of the group. This may e.g. be done by referral to different MAC numbers or other suitable measures.

The wireless access point of a subscriber may thus e.g. be grouped with further wireless repeaters. Wireless repeaters are commonly used to improve signal range and strength of a wireless network. A wireless repeater (also called wireless range extender) takes an existing signal from a wireless router or access point and rebroadcasts it to create a second network. When two or more hosts have to be connected with one another over the IEEE 802.11 protocol and the distance is too long for a direct connection to be established, a wireless repeater is used to bridge the gap. It can be a specialized stand-alone computer networking device. Also, some wireless network interface controllers optionally support operating in such a mode.

Those outside of the primary network will be able to connect through the new “repeated” network. However, as far as the original router or access point is concerned only the repeater's MAC-address is connected.

In a preferred embodiment the wireless repeater is configured with wireless network settings, SSID and security credentials identically to the wireless access points participating in a united network UN, thereby simply extending the coverage area CA of the united network.

It is noted, that the terms advertising and advertisement are used interchangeably in the present disclosure.

### THE DRAWINGS

The invention will in the following be described with reference to the drawings where

FIG. 1A is a block diagram illustrating an embodiment of the invention,

FIG. 1B is a flow chart illustrating an embodiment of the invention,

FIG. 2 is a block diagram illustrating various embodiments of the invention, and

FIG. 3 is a block diagram illustrating an embodiment of a hybrid advertising network according to an embodiment of the invention.

### DETAILED DESCRIPTION

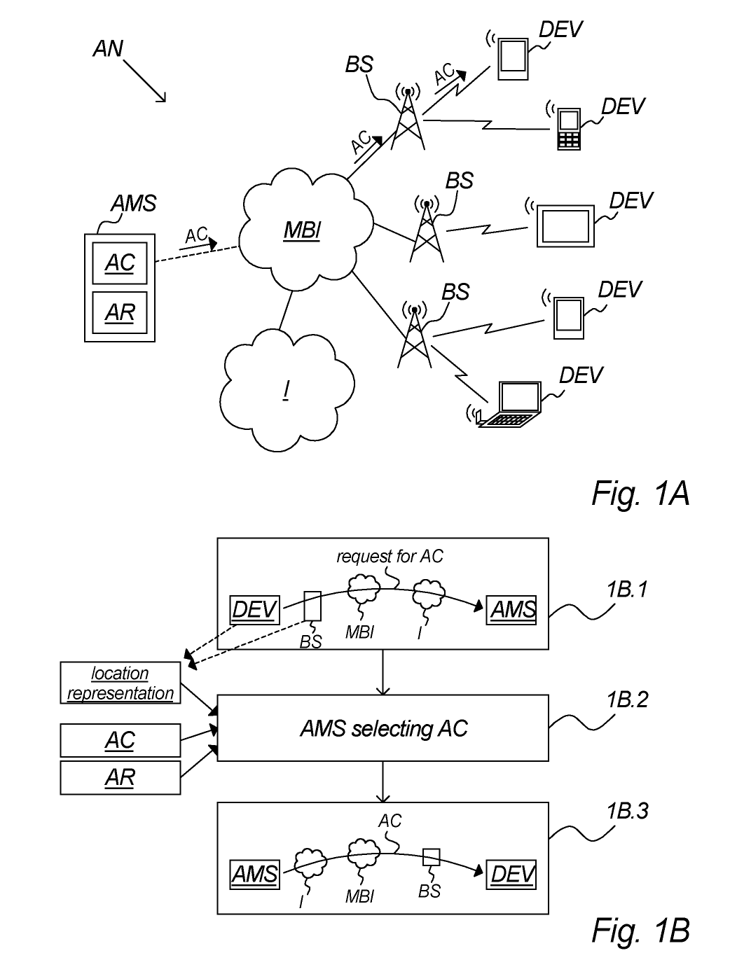

FIG. 1A is a block diagram illustrating an embodiment of an advertising network AN according to an embodiment of the invention. A mobile broadband infrastructure MBI comprising or connected to a number of base stations BS form a platform to allow a number of mobile devices DEV to connect to the internet I. Further, the advertising network AN comprises an advertising management system AMS, at least comprising advertising content AC and advertising rules AR. The dashed connection between the advertising management system AMS and the mobile broadband infrastructure MBI indicates that the advertising management system may be part of the mobile broadband infrastructure, or otherwise be connected directly to it, or the two may be communicatively coupled via the internet I.

Examples and alternatives for the different components and structures are disclosed and discussed above, and any, some or all possibilities, alone or in combination, are within the scope of the present invention and applicable to various embodiments thereof.

Note that FIG. 1A comprises a mobile device being a laptop computer with a mobile broadband modem incorporated in a USB stick for establishing connection with the mobile broadband.

FIG. 1B is a flow chart illustrating an embodiment of using the above described advertising network AN for distributing advertising content AC to the mobile devices DEV. In a first step 1B.1 is illustrated, that a mobile device DEV sends a request for advertising content AC to the advertising management system AMS. As indicated in FIG. 1B, the request preferably goes through the base station BS, the mobile broadband infrastructure MBI and the internet I. As mentioned above, alternative routes may be imagined within the scope of the present invention.

In a second step 1B.2 the advertising management system AMS selects which advertising content AC to respond with. To make this selection the advertising management system AMS makes use of a pool of advertising content AC, some advertising rules AR, and a location representation.

As indicated by the dashed arrows, the location representation is related to any or both of the mobile device DEV or the base station BS. It is noted that the location representation may also or alternatively relate to other base stations, for example when based on multilateration, trilateration or triangulation between 2, 3 or more base stations. Various considerations regarding the location representation are also disclosed above in relation to location representative data LRD. The location representation is in a preferred embodiment provided to the advertising management system AMS together with or as part of the request for advertising content, and may either be added to the request by the mobile device DEV or the base station BS or other network components that the request passes on its way to the advertising management system AMS.

The advertising content AC to select from is preferably categorized or otherwise associated with an indication of geographical relevance, so that the advertising management system AMS by means the advertising rules AR, which may e.g. comprise an algorithm or filter configured to use the location representation for selecting one or more individual advertisements that targets the location or estimated location of the mobile device.

The third step 1B.3 illustrates that when the advertising management system AMS has selected advertising content to use as response to the request, it distributes this advertising content AC to the DEV who requested it, preferably via the internet I, mobile broadband infrastructure MBI and base station BS as elaborated on, mutatis mutandis, for the opposite direction above. This step is also illustrated in FIG. 1A by the indication of advertising content AC being transferred along the illustrated connections from the advertising management system AMS to the mobile broadband infrastructure MBI, to the base station BS and finally to a mobile device DEV.

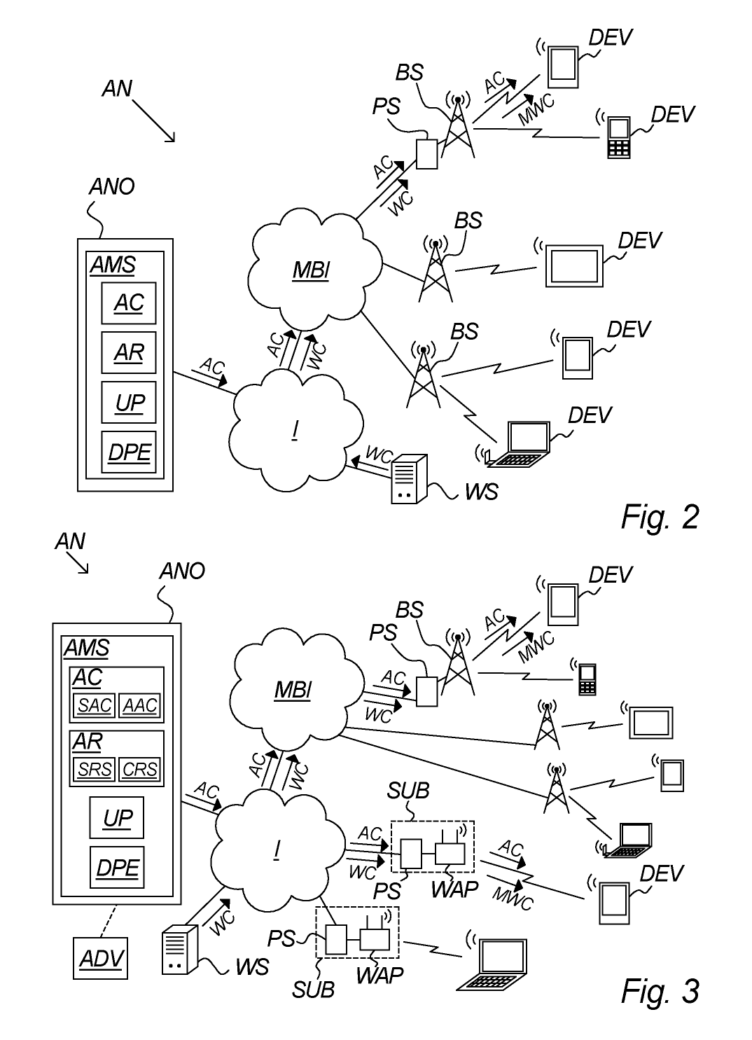

FIG. 2 illustrates various embodiments of the invention based on the illustration of FIG. 1A. The various additional features may all be present in a preferred embodiment, but various embodiments comprise different combinations of some or all of the features of FIG. 2.

In an embodiment derivable from FIG. 2 the advertising management system AMS is illustrated as being comprises by an advertising network operator ANO, who operates the advertising management server AMS and preferably facilitates the advertising network AN. The advertising network operator ANO may be comprised by or a subsidiary of the mobile network operator operating the mobile broadband infrastructure MBI, or the advertising network operator may be a separate entity with separate interests.

In an embodiment derivable from FIG. 2 the advertising network operator ANO and thereby the advertising managing system AMS is connected to the internet I, and uses the internet for distribution of advertising content AC.

In an embodiment derivable from FIG. 2 the advertising management system AMS comprises user profiles UP, preferably related to the mobile devices or users of the mobile devices. Various embodiments relating to the establishment of and use of the user profiles UP are disclosed above.

In an embodiment derivable from FIG. 2 the advertising management system AMS comprises data processing equipment DPE comprising hardware and software for performing the tasks of the advertising management system AMS.

In an embodiment derivable from FIG. 2 a web server WS as further discussed above is also connected to the internet I, and the mobile device requests web content WC from the web server WS. As illustrated in FIG. 2, the retrieval and transmission of web content WC does in a preferred embodiment not involve the advertising management system AMS. The web content may in a preferred embodiment comprise a web page, typically based on an HTML-document, but any web content may be retrieved in accordance with various embodiments of the invention.

In an embodiment derivable from FIG. 2 proxy servers PS are located in relation to the base stations BS. In a preferred embodiment the proxy servers are located close to the base stations in terms of connection length or routing hops, preferably integrated in the base station's routing software, in order to distribute the required proxy processing power as much as possible. In an embodiment one or more proxy servers are located upstream from a number of base stations in order to process all traffic collectively for those base stations, thereby requiring less proxy servers but with higher processing power demands on each. The proxy servers PS are in a preferred embodiment configured to manipulate the web content WC into modified web content before it is transmitted to the mobile device. The manipulation preferably comprises adding code, e.g. text, graphical items, a script or other instructions, that makes the mobile device request advertising content AC when processing the received modified web content MWC. Any modification of web content suitable for making the mobile device request advertising content is within the scope of the invention, and various embodiments thereof are disclosed above. In a preferred embodiment the proxy server modifies all or some HTML-documents transmitted in accordance with the hypertext transfer protocol (HTTP).

FIG. 3 illustrates various embodiments of a hybrid advertising network according to the invention, comprising both distribution of advertising content AC to mobile broadband connected mobile devices as illustrated in FIG. 1A and 2, as well as distribution of advertising content AC to wireless broadband (i.e. WiFi) connected mobile devices. The various features may all be present in a preferred embodiment, but various embodiments comprise different combinations of some or all of the features of FIG. 3.

In an embodiment derivable from FIG. 3 a number of individual subscribers SUB, preferably representing individual shops, cafés, malls, private or public properties, etc., comprises wireless access points WAP by which they offer wireless internet access by WiFi-technology to mobile devices DEV with such capabilities. The mobile devices connected to the wireless access points WAP may thereby retrieve web content WC from the web servers WS connected to the internet I.

Note that FIG. 3 comprises a mobile device being a laptop computer with integrated WiFi technology for establishing wireless connection with a wireless access point WAP.

In an embodiment derivable from FIG. 3 the subscribers SUB also comprise proxy servers PS in relation to the wireless access points WAP. The purpose and functionality of the proxy servers are the same as described above for the base stations-related proxy servers, i.e. to modify web content WC into modified web content MWC which makes the mobile device DEV requesting advertising content AC when processing the modified web content MWC.

In an embodiment derivable from FIG. 3 the advertising management system AMS comprises as part of the advertising content AC some subscriber-defined advertising content SAC and as part of the advertising rules AR a subscriber rule set SRS. The subscriber-defined advertising content SAC is prepared, selected or controlled by the individual subscribers, and hence comprises for example local advertisement or announcements. By the subscriber rule set may in a preferred embodiment be achieved that a specific subscriber's wireless access point is used to only distribute his own subscriber-defined advertising content SAC and not subscriber-defined advertising content of the neighbour or competitor.

In an embodiment derivable from FIG. 3 the advertising management system AMS comprises as part of the advertising content AC some advertising network operator-defined advertising content AAC and as part of the advertising rules AR a compliance rule set CRS. The advertising network operator-defined advertising content AAC is prepared, selected or controlled by the advertising network operator ANO, e.g. as received from advertisers ADV in accordance with an advertiser billing plan. The advertising network operator-defined advertising content AAC may have local relevance or be general advertisement. The compliance rule set CRS may in a preferred embodiment be used to control that specific subscriber's wireless access point is not used to distribute advertising network operator-defined advertising content AAC which conflicts with his interests, e.g. by categorizing the advertising content with industrial classification codes. The compliance rule set CRS may in a preferred embodiment be used to control that advertising network operator-defined advertising content AAC are distributed where it may be thought to be most relevant for mobile device users, e.g. by categorizing the subscribers with industrial classification codes and/or categorizing the advertising network operator-defined advertising content AAC with geographical relevancy parameters.

In an embodiment derivable from FIG. 3 the advertising management system AMS may use one or more of the subscriber-defined advertising content SAC, the advertising network operator-defined advertising content AAC, the subscriber rule set SRS and the compliance rule set CRS when selecting advertising content AC to send to mobile devices connected via the mobile broadband infrastructure MBI.

In a preferred embodiment the mobile device users are motivated to accept receiving the advertising content because it is part of a data plan offered for free or at a reduced rate by a mobile network operator and the advertisements are even in a preferred embodiment particularly relevant for the geographical location of the user. The mobile network operator may achieve increased interest from mobile device users due to the free or cheap data plans it is enabled to offer because of the revenue received from advertisers. The advertisers are interested in buying advertising from the mobile network operator or an advertising network operator ANO operating the advertising network AN because of the awareness of location relevance that makes users more likely to react positively on the advertisements.

In an embodiment a mobile network operator operating the mobile broadband infrastructure MBI accepts connections from mobile devices that do not already have a customer relationship with that mobile network operator. This may be achieved by disregarding what services the user's mobile device can access as identified by the subscriber identity module (SIM card) of the user's mobile device, and simply connect the user's mobile device to the ad-supported mobile broadband connection. In an embodiment, the mobile network operator's own customers with special data plans not involving advertising, e.g. offered for a higher price, are not connected to the ad-supported connection. The revenue from advertising and increased interest from users may in an embodiment make it feasible for a mobile network operator to offer free, advertising-supporting mobile broadband to all mobile device users within reach, regardless of their individual customer relationship with the mobile network operator or its competitors.

1. A method of distributing advertising content in an advertising network, the advertising network comprising
an advertising management system configured to manage advertising content; and a mobile broadband infrastructure comprising a plurality of base stations configured to provide communicatively coupling of mobile devices to the internet, the communicatively coupling at least partly being established as a mobile broadband connection; said mobile broadband infrastructure being communicatively coupled to said advertising management system; said advertising management system being configured to select and distribute advertising content to said mobile devices in accordance with advertising rules; and wherein said advertising rules provides for distributing said advertising content to mobile devices according to at least one of a location of the mobile devices or a location of the base stations; the method comprising the steps of
the advertising management system receiving a request for advertising content from a first mobile device communicatively coupled to the internet via a first base station;
the advertising management system selecting an advertising content in accordance with said advertising rules and at least partly based on at least one of a location representation of said first mobile device or a location representation of said first base station; and
distributing the selected advertising content to the first mobile device in response to said request.

2. The method of claim 1, wherein the method is performed automatically by means of data processing equipment.

3. The method of claim 1, wherein said communicatively coupling of the mobile devices to the internet by means of a mobile broadband connection is provided for free or at a, preferably reduced, rate in return for the users of the mobile devices agrees to receiving said advertising content.

4. The method of claim 1, wherein said advertising management system is operated by an advertising network operator.

5. (canceled)

6. (canceled)

7. (canceled)

8. The method of claim 1, wherein at the step of selecting advertising content to distribute to the first mobile device via said first base station is performed at least partly in dependency with a user profile associated with the mobile device or a user of the mobile device.

9. The method of claim 1, wherein the advertising rules furthermore relates to a user profile associated with the mobile device or a user of the mobile device, and wherein the advertising content is further selected in accordance with the user profile.

10. The method of claim 8, wherein the user profile is updated by means of input from a user.

11. The method of claim 8, wherein the user profile is updated in response to analysis of web content or web search results accessed by the mobile device or the user of the mobile device.

12. The method of claim 1, wherein the advertising management system selecting an advertisement content in accordance with said advertising rules and at least partly based on at least one of a location representation of said first mobile device or a location representation of said first base station is based on a unique ID associated with said request.

13. The method of claim 12, wherein said unique ID is determined based on a positioning system of said mobile device performing the requests for advertising content.

14. The method of claim 12, wherein said unique ID is determined based on multilateration, trilateration or triangulation, preferably with respect to a plurality of base stations, to determine the position of said mobile device performing the request(s) for advertising content.

15. The method of claim 1, wherein said location representation is combined into the requests for advertisement content.

16. The method of claim 15, wherein the combining of said location representation into said requests for advertising content is triggered by said mobile device.

17. The method of claim 15, wherein the combining of said location representation into said requests for advertising content is triggered by said advertising network.

18. The method of claim 15, wherein the combining of said location representation into said requests for advertising content is triggered by the base station through which the request is transmitted from said mobile device.

19. The method of claim 1, wherein the base stations are further configured to communicatively couple said mobile devices to the internet for retrieval of web content.

20. (canceled)

21. (canceled)

22. (canceled)

23. (canceled)

24. (canceled)

25. The method of claim 1, wherein the advertising management system facilitates a central uploading of individual advertising content via the Internet.

26. The method of claim 1, wherein said web content retrieved by said mobile device is received and displayed at the mobile device.

27. The method of claim 1, wherein said advertising content transmitted to said mobile device is received and displayed at the mobile device.

28. The method of claim 1, wherein the advertising content distributed to the mobile device is received and displayed at the mobile device in addition to web content requested by the mobile device.

29. The method of claim 1, wherein the advertising content transmitted to the mobile device is displayed at the mobile device simultaneously with web content requested by the mobile device.

30. The method of claim 1, wherein the mobile broadband infrastructure comprise proxy servers.

31. The method of claim 1, wherein said proxy servers trigger the association of a location representation or unique ID.

32. The method of claim 1, wherein the mobile device connecting to the base station receives advertising content from the advertising management system and web content from the internet, preferably from a web server connected to the internet.

33. The method of claim 1, wherein the mobile device connecting to the base station receives advertising content from the advertising management system and web content from the internet, preferably from a web server connected to the internet, wherein the web content is transmitted from the internet without being relayed via the advertising management system.

34. The method of claim 1, wherein said communicatively coupling of mobile devices to the internet does not involve WiFi-technology.

35. The method of claim 1, wherein the base stations are configured to enable communicatively coupling of a plurality of mobile devices to the internet regardless of customer relationships or service accessibilities indicated by subscriber identity modules comprised by said plurality of mobile devices.

36. A system for facilitating advertising in an advertising network, the system comprising
an advertising management system configured to manage advertising content; and
a mobile broadband infrastructure comprising a plurality of base stations configured to provide communicatively coupling of mobile devices to the internet, the communicatively coupling at least partly being established as a mobile broadband connection;
said mobile broadband infrastructure being communicatively coupled to said advertising management system;
said advertising management system being configured to select and distribute advertising content to said mobile devices in accordance with advertising rules; and
wherein said advertising rules are configured to enable said selection of advertising content according to at least one of a location of the mobile devices or a location of the base stations.

37. (canceled)

38. The system of claim 36 wherein said system further comprises features for carrying out the method according to claim 1.

39. A non-transitory computer-readable storage medium storing a set of instructions for distributing advertising content in an advertising network, the advertising network comprising an advertising management system configured to manage advertising content; and a mobile broadband infrastructure comprising a plurality of base stations configured to provide communicatively coupling of mobile devices to the internet, the communicatively coupling at least partly being established as a mobile broadband connection; said mobile broadband infrastructure being communicatively coupled to said advertising management system; said advertising management system being configured to select and distribute advertising content to said mobile devices in accordance with advertising rules; and wherein said advertising rules provides for distributing said advertising content to mobile devices according to at least one of a location of the mobile devices or a location of the base stations;
said instructions, when executed by one or more processors, cause the following steps to be carried out:
the advertising management system receiving a request for advertising content from a first mobile device communicatively coupled to the internet via a first base station;
the advertising management system selecting an advertising content in accordance with said advertising rules and at least partly based on at least one of a location representation of said first mobile device or a location representation of said first base station; and
distributing the selected advertising content to the first mobile device in response to said request.

40. The method of claim 8, wherein said advertising management system is further communicatively coupled to a plurality of geographically distributed wireless access points, and wherein the user profile is updated in response to analysis of mobile device references obtained by said wireless access points.

41. The method of claim 40, wherein said mobile device references are MAC-addresses.
